(19) United States
(12) Patent Application Publication
(10) Pub. No.: US 2004/0098340 A1
(43) Pub. Date: May 20, 2004

(54) Financial document processing system and method of operating a financial document processing system to detect a piggyback condition

(75) Inventors: Susan H. Schott, Waterloo (CA); James W.D. Fare, Waterloo (CA); Kenneth G. De Souza, Kitchener (CA); Sean Woodward, Waterloo (CA)

Correspondence Address: MICHAEL CHAN, NCR CORPORATION, 1700 SOUTH PATTERSON BLVD, DAYTON, OH, 45479-0001, US

(73) Assignee: NCR Corporation, Dayton, OH

(21) Appl. No.: 10/294,951

(22) Filed: Nov. 14, 2002

(51) Int. Cl. G06F 17/60

(52) U.S. Cl. 705/45

(57) ABSTRACT

A method of operating a check processing system having a document item transport path and a radio frequency identification (RFID) tag reader disposed along the document transport path comprises the steps of (a) transmitting an interrogating signal from the RFID tag reader towards RFID tagged documents transported along the document transport path, (b) receiving a first signal from an RFID tag of a first document transported along the document transport path when the RFID tag of the first document detects the interrogating signal, (c) receiving a second signal from an RFID tag of a second document transported along the document transport path when the RFID tag of the second document the interrogating signal, and (d) generating a status signal indicative of a piggyback condition associated with the first and second documents when the first and second signals are received within a predetermined time period. The method may further comprise the step of (e) processing the status signal to alert an operator of the presence of the piggyback condition. As an example, operation of the check processing system may be halted based upon the status signal to alert an operator of the presence of the piggyback condition. Alternatively, the method may further comprise the step of (e) storing the status signal for processing at a later time to alert an operator of the presence of the piggyback condition.

### BACKGROUND OF THE INVENTION

The present invention relates to financial document processing systems, and is particularly directed to a method of operating a financial document processing system, such as an image-based check processing system, to detect a piggyback condition.

A typical image-based check processing system includes a check processing transport which has a document transport path and a number of different hardware devices lying along the document transport path for performing specific document processing operations on documents moving downstream along the document transport path. Hardware devices lying along the document transport path may include one imaging camera disposed on one side of the document transport path for capturing an image of the frontside of a document and another imaging camera disposed on the other side of the document transport path for capturing an image of the backside of the document as the document moves downstream along the document transport path. The check processing system also includes a transport processor which executes a transport application program which is stored in memory to control operation of the devices lying along the document transport path and thereby to control operation of the check processing transport.

From time to time, a piggyback condition may occur while processing documents on the check processing transport. A piggyback condition occurs when two documents overlap each other as the documents move downstream along the document transport path. Such a condition is undesirable because neither document will be properly processed. For example, when two overlapping documents are moving downstream along the document transports path, one imaging camera captures an image of the frontside of one document and the other imaging camera captures an image of the backside of the other document. This results in the image of the frontside of one document and the image of the backside of the other document being associated together. Accordingly, neither document can be properly processed when a piggyback condition occurs.

In known check processing systems, piggyback conditions are usually identified by an operator of a check processing workstation such as a keying and balancing workstation, a codeline completion workstation, or an amount keying workstation. Operators of these workstations visually inspect images of documents which have been processed at the check processing transport, and enter data as necessary to complete codelines, complete amounts, and to balance amounts associated with the documents which have been processed at the check processing transport. There are a number of drawbacks when depending upon an operator of a check processing workstation to identify piggyback conditions. Drawbacks include inconsistency and lack of reliability due at least in part to abilities of different operators to identify piggyback conditions. It would be desirable to provide a more consistent and more reliable way of identifying presence of piggyback conditions when checks are processed.

### SUMMARY OF THE INVENTION

In accordance with one aspect of the present invention, a check processing system for processing checks comprises means defining a document item transport path along which documents can be transported from an upstream end to a downstream end, and a radio frequency identification (RFID) tag reader disposed along the document transport path. The RFID tag reader includes (i) means for transmitting an interrogating signal towards RFID tagged documents transported along the document transport path, (ii) means for receiving a first signal from an RFID tag of a first document transported along the document transport path when the first document receives the interrogating signal, and (iii) means for receiving a second signal from an RFID tag of a second document transported along the document transport path when the second document receives the interrogating signal. The check processing system further comprises means for generating a status signal indicative of a piggyback condition associated with the first and second documents when the first and second signals are received within a predetermined time period.

The check processing system may further comprise means for processing the status signal to alert an operator of the presence of the piggyback condition. As an example, operation of the check processing system may be halted based upon the status signal to alert an operator of the presence of the piggyback condition. Alternatively, the check processing system may further comprise means for storing the status signal for processing at a later time to alert an operator of the presence of the piggyback condition.

In accordance with another aspect of the present invention, a method of operating a check processing system having a document item transport path and a radio frequency identification (RFID) tag reader disposed along the document transport path comprises the steps of (a) transmitting an interrogating signal from the RFID tag reader towards RFID tagged documents transported along the document transport path, (b) receiving a first signal from an RFID tag of a first document transported along the document transport path when the RFID tag of the first document receives the interrogating signal, (c) receiving a second signal from an RFID tag of a second document transported along the document transport path when the RFID tag of the second document receives the interrogating signal, and (d) generating a status signal indicative of a piggyback condition associated with the first and second documents when the first and second signals are received within a predetermined time period.

In accordance with still another aspect of the present invention, a check processing system for processing checks comprises means defining a document item transport path along which documents can be transported from an upstream end to a downstream end, and a radio frequency identification (RFID) tag reader disposed along the document transport path. The RFID tag reader includes (i) means for transmitting an interrogating signal towards RFID tagged documents transported along the document transport path, (ii) means for receiving a first signal from an RFID tag of a first document transported along the document transport 25 path when the RFID tag of the first document detects presence of the interrogating signal, and (iii) means for receiving a second signal from an RFID tag of a second document transported along the document transport path when the RFID tag of the second document detects presence of the interrogating signal. The check processing system further comprises means for generating a status signal indicative of a piggyback condition associated with the first and second documents when the first and second signals are received within a predetermined time period.

The check processing system may further comprise means for processing the status signal to alert an operator of the presence of the piggyback condition. As an example, operation of the check processing system may be halted based upon the status signal to alert an operator of the presence of the piggyback condition. Alternatively, the check processing system may further comprise means for storing the status signal for processing at a later time to alert an operator of the presence of the piggyback condition.

In accordance with yet another aspect of the present invention, a method of operating a check processing system having a document item transport path and a radio frequency identification (RFID) tag reader disposed along the document transport path comprises the steps of (a) transmitting an interrogating from the RFID tag reader towards RFID tagged documents transported along the document transport path, (b) receiving a first signal from an RFID tag of a first document transported along the document transport path when the RFID tag of the first document detects the interrogating signal, (c) receiving a second signal from an RFID tag of a second document transported along the document transport path when the RFID tag of the second document detects the interrogating signal, and (d) generating a status signal indicative of a piggyback condition associated with the first and second documents when the first and second signals are received within a predetermined time period.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic block representation of an image-based check processing system embodying the present invention;

FIG. 2 is a schematic block representation of a portion of FIG. 1;

FIG. 3 is a diagram of a check having a radio frequency identification (RFID) tag;

FIG. 4 is a flowchart depicting operation of a program carried out in accordance with the present invention;

FIG. 5 is a diagram of a single document like the check shown in FIG. 3 being transported along a document transport path of the image-based check processing system of FIG. 1;

FIG. 6 is a diagram of two documents being transported along a document transport path of the image-based check processing system of FIG. 1;

FIG. 7 is a diagram similar to the diagram of FIG. 6 and showing the two documents in different positions;

FIG. 8 is a diagram of two completely overlapping documents being transported along a document transport path of the image-based check processing system of FIG. 1;

FIG. 9 is a diagram of two partially overlapping documents being transported along a document transport path of the image-based check processing system of FIG. 1; and

FIG. 10 is a diagram of two documents in relatively close proximity to each other being transported along a document transport path of the image-based check processing system of FIG. 1.

### DETAILS OF THE INVENTION

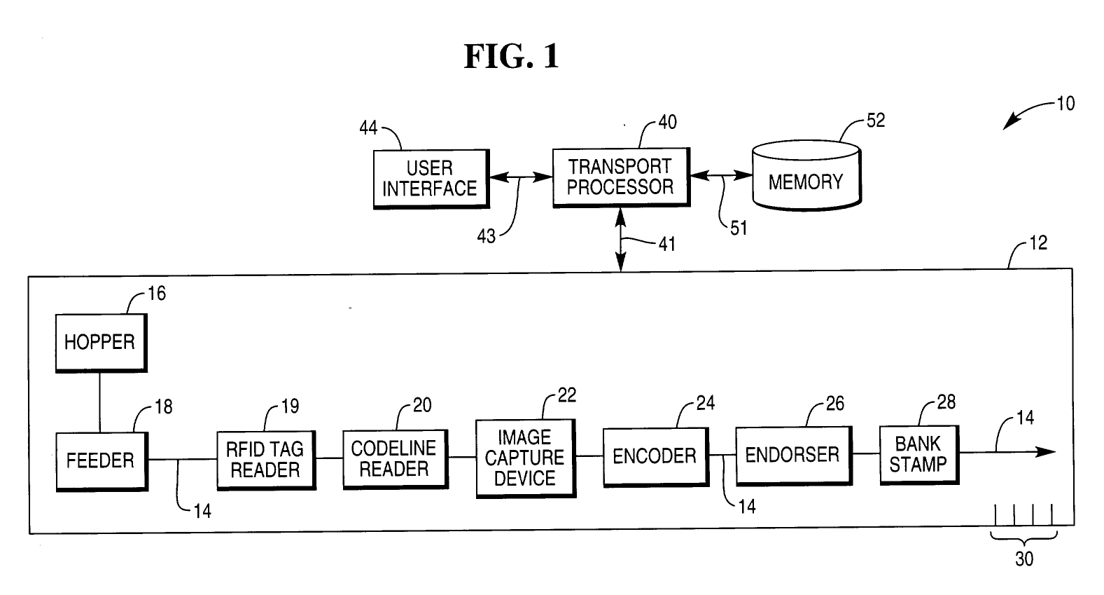

The present invention is directed to a financial document processing system and a method of operating a financial document processing system to detect a piggyback condition. The specific construction and use of the financial document processing system may vary. By way of example, a financial document processing system in the form of an image-based check processing system 10 is illustrated in FIG. 1. The check processing system 10 may be, for example, a sorting machine or a proof machine wherein financial documents such as checks are processed in a data processing operation.

As shown in FIG. 1, the check processing system 10 includes a check processing transport 12 having a document track which defines a document transport path 14 along which financial documents, such as checks, can be transported from an upstream end to a downstream end. The transport 12 includes a number of different hardware devices lying along the document transport path 14 for performing specific document processing operations on documents moving along the document transport path 14. The transport 12 includes a hopper 16 into which a stack of financial documents including checks are placed. A document feeder 18 adjacent the hopper 16 selectively feeds or drives each document from the stack of documents in the hopper to transport the document from the upstream end to the downstream end along the document transport path 14 to sorting bins 30 located at the end of the document transport path. Accordingly, documents are moving from left to right (as viewed looking at FIG. 1).

The check processing system 10 further includes a radio frequency identification (RFID) tag reader 19. The RFID tag reader 19 may be of the type which emits radio waves at a predetermined frequency at a number of different times. The range of the emitted radio waves depend upon a number of different factors including the predetermined frequency used and the power output of the emitted radio waves, as is known. The range of the emitted radio waves is set so that a“read window” is created along a portion of the document transport path 14, as will be described in detail later. The structure and operation of RFID tag readers are well known and, therefore, will not be described.

A codeline reader 20, such as a MICR reader, located along the document transport path 14 reads a MICR codeline from each check being processed in a known manner. Alternatively, the codeline reader may be an OCR reader instead of a MICR reader depending upon on the particular application. An image capture device 22 located along the document transport path 14 captures an image of each document for a number of different purposes well known in the art. More specifically, the image capture device 22 includes an imaging camera (not shown) which is controlled to capture images of documents moving along the document transport path 14. An encoder 24 encodes missing fields on each check. An endorser 26 applies an endorsement in a known manner to each check. A bank stamp 28 stamps each check to identify the bank institution processing the check. The structure and operation of MICR readers, OCR readers, image capture devices, encoders, endorsers, and bank stamps are well known and, therefore, will not be described.

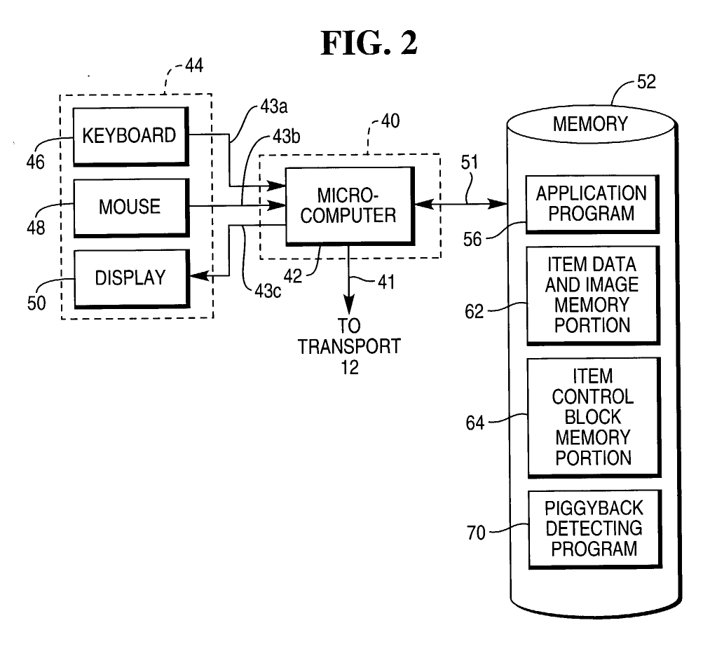

Referring to FIGS. 1 and 2, the check processing system 10 further includes a transport processor 40 and a user interface 44 which communicates via signals on line 43 (FIG. 1) with a microcomputer 42 of the transport processor 40. The user interface 44 includes a keyboard 46, a mouse 48, and a display 50, all of which communicate via signals on lines 43a, 43b, 43c (FIG. 2) with the microcomputer 42. Suitable microcomputers and memories are readily available in the marketplace. Their structure and operation are well known and, therefore, will not be described. The microcomputer 42 controls operation of the transport 12 via signals on line 41.

The check processing system 10 also includes a memory 52 which communicates via signals on line 51 with the microcomputer 42. It is contemplated that the memory 52 could be a single memory unit or a plurality of different memory units. An executable transport application program 56 is stored in the memory 52. The transport application program 56 is associated with a particular type of document processing work. For example, one type of work is proof of deposit. Another type of work is remittance processing. Still another type of work may be sorting of items. When the transport application program 56 is executed, the hardware devices lying along the document transport path 14 are controlled to process items moving downstream along the document transport path 14 in accordance with the transport application program, as is known.

The memory 52 includes an item data and image memory portion 62 which stores sequence numbers, MICR codelines, image data, encoder status, endorsement status, and bank stamp status associated with transaction items which have been processed in accordance with the transport application program 56. The memory unit 52 further includes an item control block memory portion 64 which may store data relating to certain items during a piggyback condition to be described later. The memory 52 also stores a piggyback detecting program 70 in accordance with the present invention to be described in more detail hereinbelow.

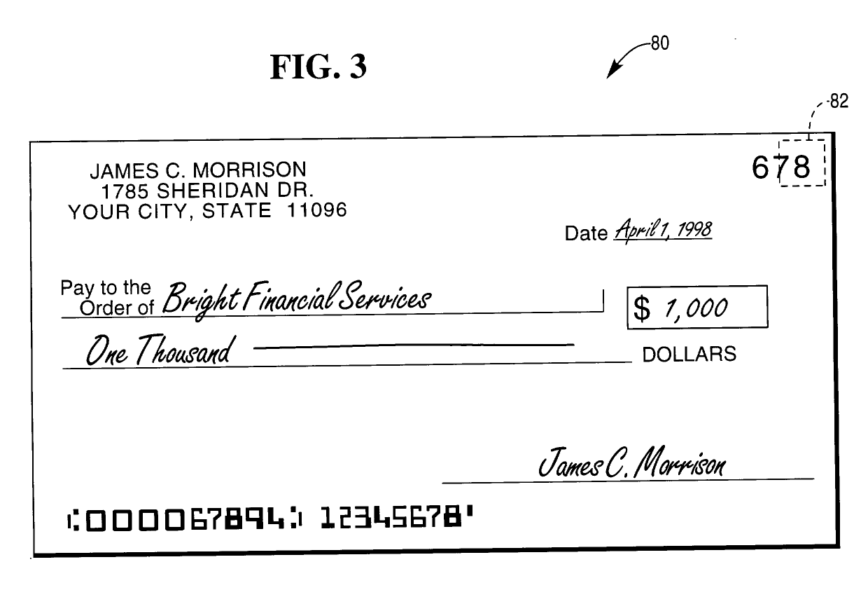

As shown in FIG. 3, a check 80 has an RFID tag 82 associated therewith. The check 80 with the RFID tag 82 may be constructed in many different ways. For example, the RFID tag 82 may be bonded to a major side surface of the check 80. As another example, the RFID tag 82 may be embedded into the sheet material of the check 80 during manufacture of the check. The RFID tag 82 includes RFID circuitry (not shown) and an RFID antenna (also not shown), as is known. The circuitry typically includes a printed circuit board on which electronic components are mounted. The antenna may be of the inductive loop type, for example. The structure and operation of the RFID tag 82 are well known and, therefore, will not be described.

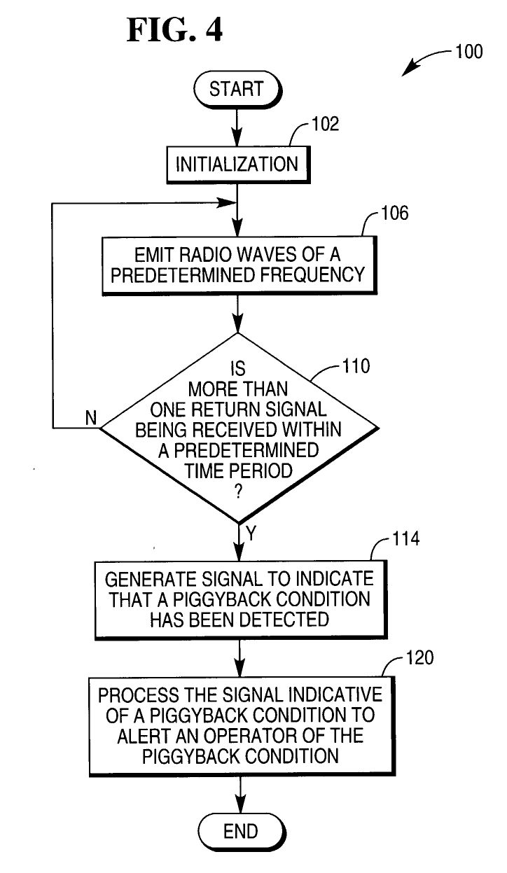

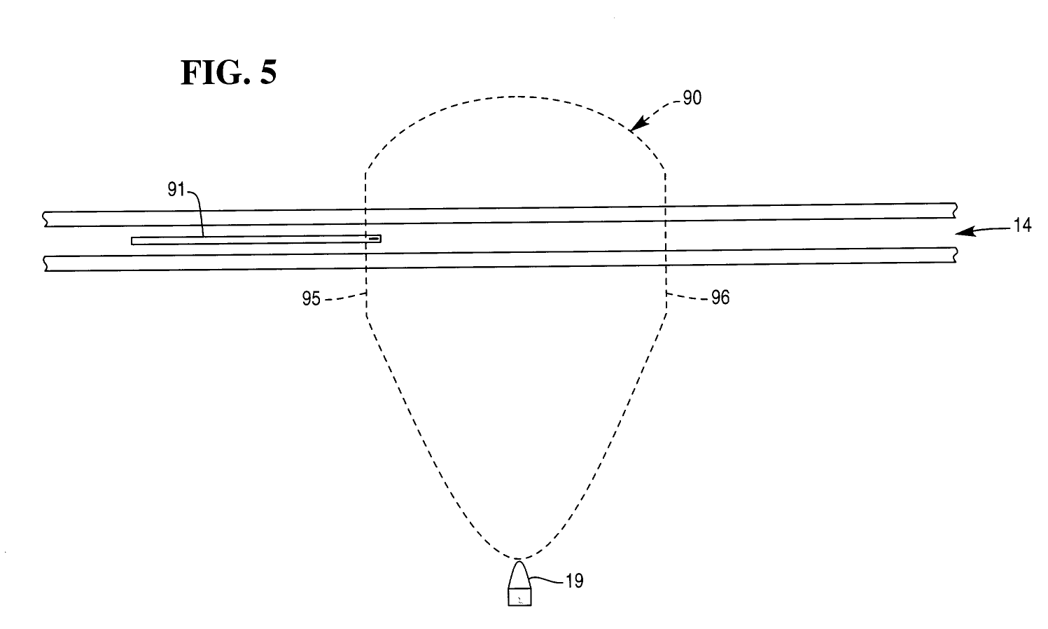

FIG. 4 is a flowchart which depicts operation of the piggyback detecting program 70 which runs continuously as each item is transported from the upstream end of the document transport path 14 towards the downstream end of the document transport path. After program initialization in step 102, the program proceeds to step 106 in which radio waves of a predetermined frequency is directed as a read envelope or window 90, as shown in FIG. 5, from the RFID tag reader 19 towards RFID tagged documents moving downstream along the document transport path 14 from left to right (as viewed looking at FIG. 5).

It should be noted from FIG. 5 that two opposite portions 95, 96 of the read envelope 90 in the vicinity of the document transport path 14 are “squared off”. The shape of the antenna of the RFID tag reader 19 is a factor in determining the shape of the squared off portions 95, 96. Shielding materials in the vicinity of the RFID tag reader 91 may be used to further determine the shape of the squared off portions 95, 96 of the read envelope 90, as is known.

In FIG. 5, a first RFID tagged document 91 is shown with its RFID tag moved just inside the read window 90. When the RFID tag of the first document 91 moves just inside the read envelope 90, the RFID tag transmits a return signal to the RFID tag reader 19. The RFID tag reader 19 detects the return signal from the RFID tag of the first document 91 in a known manner.

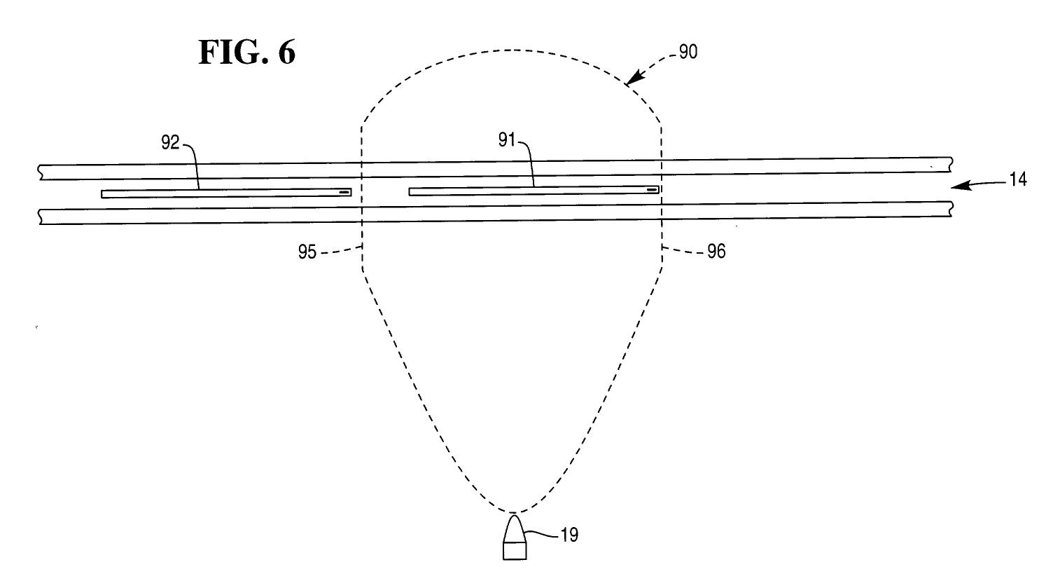

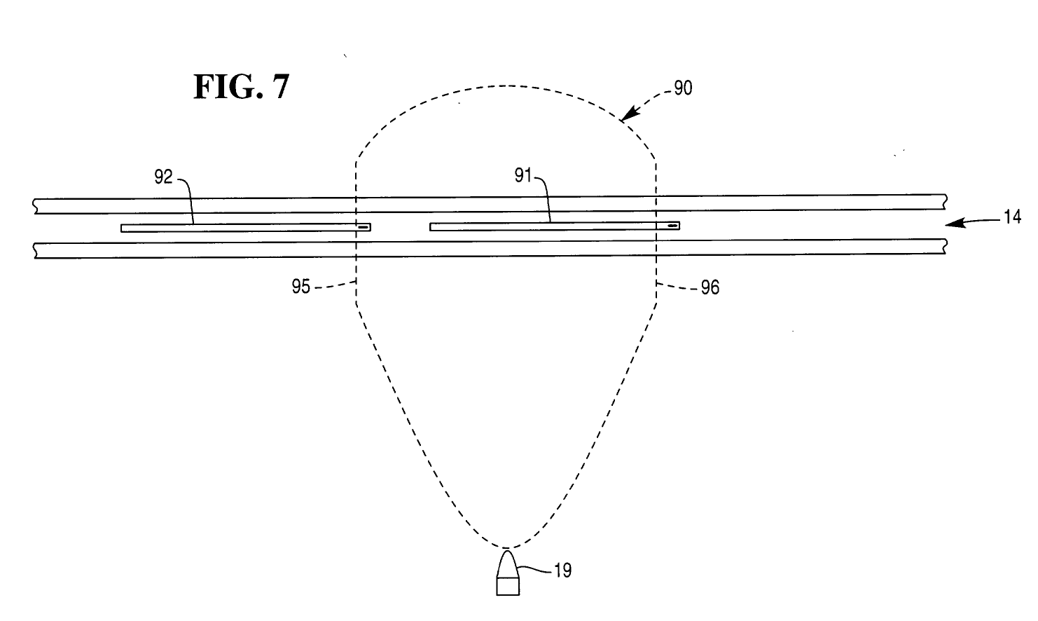

The first document 91 continues moving downstream from the position shown in FIG. 5 to a position such as shown in FIG. 6. In FIG. 6, the RFID tag of the first document 91 is still within the read envelope 90. At this time, an RFID tag of a second RFID tagged document 92 is also moving downstream along the document transport path 14. As shown in FIG. 6, the RFID tag of the second document 92 is just outside of the read window 90. As the first and second documents continue to move downstream to a position such as shown in FIG. 7, the RFID tag of the first document 91 has moved outside of the read window 90 just as the RFID tag of the second document 92 moves inside the read window. The movement of the first and second documents 91, 92 downstream along the document transport path 14, as shown in FIGS. 5, 6, and 7 is considered proper (i.e., no piggyback condition) because the RFID tag of the first document 91 and the RFID tag of the second document 92 are not at any moment both within the read window 90. When the RFID tag reader 19 does not detect more than one return signal within a predetermined time period, the program in step 110 of FIG. 4 loops back to step 106 to continue emitting radio waves of a predetermined frequency towards RFID tagged documents moving downstream along the document transport path 14.

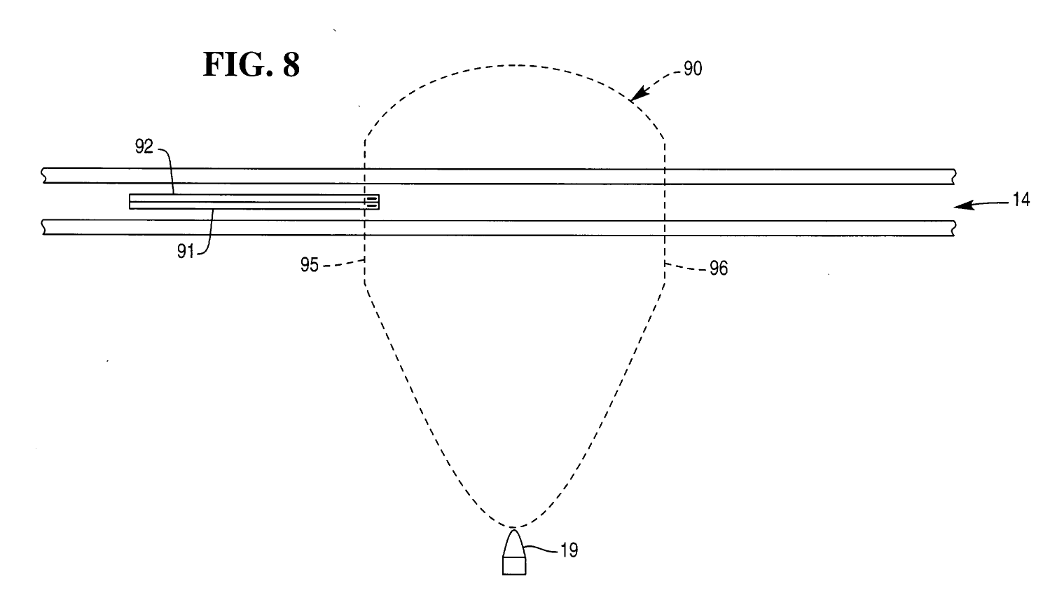

A piggyback condition of the first and second documents 91, 92 is shown in FIG. 8 which shows the first and second documents completely overlapping each other. When this occurs, the RFID tags of both the first and second documents 91, 92 move within the read window 90 at the same time and transmit their return signals to the RFID tag reader 19. When the RFID tag reader 19 detects more than one return signal within the predetermined time period, the program in step 10, of FIG. 4 proceeds to step 114 in which a signal is generated to indicate that a piggyback condition of the first and second documents 91, 92 has been detected. The predetermined time period will depend upon a number of different factors including operating track speed of the check processing transport 12, for example.

The program then proceeds to step 120 in FIG. 4 in which the generated signal from step 114 indicative of the presence of a piggyback condition is further processed for the purpose of alerting an operator to the presence of the piggyback condition. As an example, the signal generated from step 114 may be processed to halt or stop operation of the check processing transport 12 when the piggyback condition of the first and second documents 91, 92 is detected. Alternatively, the signal generated from step 114 may be stored in the item control block memory portion 64 (FIG. 2) for later use in alerting an operator to the presence of the piggyback condition. It should be apparent from the above description that the piggyback detecting program 70 operates automatically, without any human intervention, to detect the presence of a piggyback condition.

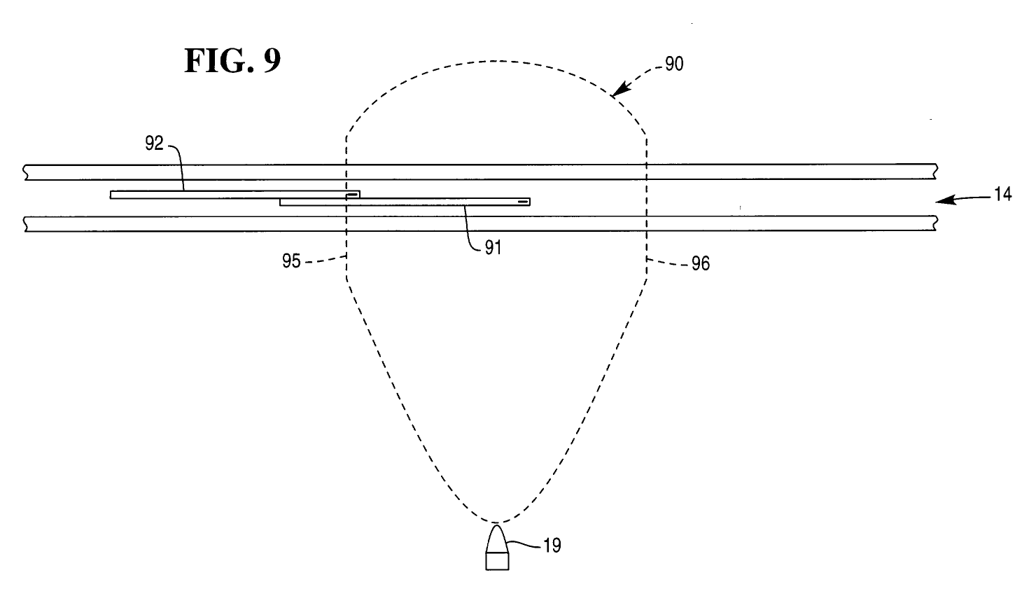

It is contemplated that other relative positions of the first and second documents 91, 92 may be considered piggyback conditions. For example, as shown in FIG. 9, the first and second documents 91, 92 are shown as be only partially overlapped. In this case, the RFID tag of the first document 91 has moved into the read window 90, and then at a later time the RFID tag of the second document 92 moves into the read window 90. When the RFID tag of the second document 92 moves into the read window 90, the RFID tag of the first document 91 and the RFID tag of the second document 92 are both within the read window 90. The RFID tag reader 19 detects more than one return signal within the predetermined time period and generates the signal indicative of a piggyback condition as previously described.

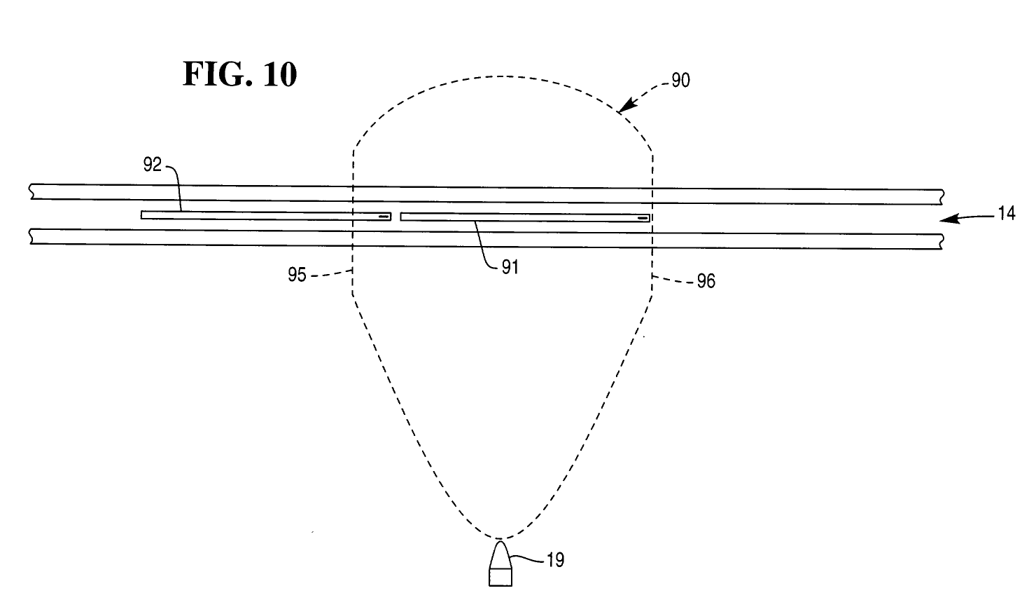

As another example of a piggyback condition, as shown in FIG. 10, the first and second documents 91, 92 are moving downstream along the document transport path 14 closer to each other than a predetermined distance. This predetermined distance will depend upon a number of different factors including operating track speed of the check processing transport 12, for example. When the first and second documents 91, 92 are closer to each other than the predetermined distance, the RFID tag of the second document 92 moves within the read window 90 before the RFID tag of the first document 91 moves outside the read window 90, such as shown in FIG. 10. When this occurs, the RFID tag reader 19 detects more than return signal within the predetermined time period and generates the signal indicative of a piggyback condition as previously described

Although the above description describes the check 80 having an RFID tag 82 located approximately along the upper right top edge portion of the main face of the check as shown in FIG. 3, it is conceivable that the RFID tag be positioned at any location associated with the check so long as the RFID tag reader 19 remains capable of detecting piggyback conditions when they occur. Moreover, RFID tag reader 19 may be located along the document transport path 14 at a location other than between the feeder 18 and the codeline reader 20.

Also, although the above description describes the piggyback detecting program 70 as being used in an image-based financial document processing system, it is contemplated that the piggyback detecting program may be used in a non-image-based financial document processing system. Moreover, it is conceivable that more than one RFID tag reader may be disposed along the document transport path 14.

Also, although the above description describes the piggyback detecting program 70 as continuously running as items move downstream along the document transport path 14, it is contemplated that a number of sensors may be used along the document transport path 14 to sense the presence of an item moving into the vicinity of the RFID tag reader 19. Output signals from the sensors may be used to trigger operation of the RFID tag reader 19.

A number of advantages result by providing a method of operating the check processing system 10 in accordance with the present invention. One advantage is that piggyback conditions are more consistently and reliably identified. Another advantage is that a relatively simple and efficient program is provided to assist the operator during transport of items along the document transport path 14 of the check processing system 10.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A check processing system for processing checks, the check processing system comprising:
means defining a document item transport path along which documents can be transported from an upstream end to a downstream end;
a radio frequency identification (RFID) tag reader disposed along the document transport path, the RFID tag reader including (i) means for transmitting an interrogating signal towards RFID tagged documents transported along the document transport path, (ii) means for receiving a first signal from an RFID tag of a first document transported along the document transport path when the first document receives the interrogating signal, and (iii) means for receiving a second signal from an RFID tag of a second document transported along the document transport path when the second document receives the interrogating signal; and
means for generating a status signal indicative of a piggyback condition associated with the first and second documents when the first and second signals are received within a predetermined time period.

2. A check processing system according to claim 1, further comprising means for processing the status signal to alert an operator of the presence of the piggyback condition.

3. A check processing system according to claim 1, further comprising means for halting operation of the check processing system based upon the status signal to alert an operator of the presence of the piggyback condition.

4. A check processing system according to claim 1, further comprising means for storing the status signal for processing at a later time to alert an operator of the presence of the piggyback condition.

5. A method of operating a check processing system having a document item transport path and a radio frequency identification (RFID) tag reader disposed along the document transport path, the method comprising the steps of:
(a) transmitting an interrogating signal from the RFID tag reader towards RFID tagged documents transported along the document transport path;
(b) receiving a first signal from an RFID tag of a first document transported along the document transport path when the RFID tag of the first document receives the interrogating signal;
(c) receiving a second signal from an RFID tag of a second document transported along the document transport path when the RFID tag of the second document receives the interrogating signal; and
(d) generating a status signal indicative of a piggyback condition associated with the first and second documents when the first and second signals are received within a predetermined time period.

6. A method according to claim 5, further comprising the step of:
(e) processing the status signal to alert an operator of the presence of the piggyback condition.

7. A method according to claim 5, further comprising the step of:
(e) halting operation of the check processing system based upon the status signal to alert an operator of the presence of the piggyback condition.

8. A method according to claim 5, further comprising the step of:
(e) storing the status signal for processing at a later time to alert an operator of the presence of the piggyback condition.

9. A check processing system for processing checks, the check processing system comprising:
means defining a document item transport path along which documents can be transported from an upstream end to a downstream end;
a radio frequency identification (RFID) tag reader disposed along the document transport path, the RFID tag reader including (i) means for transmitting an interrogating signal towards RFID tagged documents transported along the document transport path, (ii) means for receiving a first signal from an RFID tag of a first document transported along the document transport path when the RFID tag of the first document detects presence of the interrogating signal, and (iii) means for receiving a second signal from an RFID tag of a second document transported along the document transport path when the RFID tag of the second document detects presence of the interrogating signal; and
means for generating a status signal indicative of a piggyback condition associated with the first and second documents when the first and second signals are received within a predetermined time period.

10. A check processing system according to claim 9, further comprising means for processing the status signal to alert an operator of the presence of the piggyback condition.

11. A check processing system according to claim 9, further comprising means for halting operation of the check processing system based upon the status signal to alert an operator of the presence of the piggyback condition.

12. A check processing system according to claim 9, further comprising means for storing the status signal for processing at a later time to alert an operator of the presence of the piggyback condition.

13. A method of operating a check processing system having a document item transport path and a radio frequency identification (RFID) tag reader disposed along the document transport path, the method comprising the steps of:
(a) transmitting an interrogating from the RFID tag reader towards RFID tagged documents transported along the document transport path;
(b) receiving a first signal from an RFID tag of a first document transported along the document transport path when the RFID tag of the first document detects the interrogating signal;
(c) receiving a second signal from an RFID tag of a second document transported along the document transport path when the RFID tag of the second document detects the interrogating signal; and
(d) generating a status signal indicative of a piggyback condition associated with the first and second documents when the first and second signals are received within a predetermined time period.

14. A method according to claim 13, further comprising the step of:
(e) processing the status signal to alert an operator of the presence of the piggyback condition.

15. A method according to claim 13, further comprising the step of:
(e) halting operation of the check processing system based upon the status signal to alert an operator of the presence of the piggyback condition.

16. A method according to claim 13, further comprising the step of:
(e) storing the status signal for processing at a later time to alert an operator of the presence of the piggyback condition.
